(19) United States
(12) Patent Application Publication
(10) Pub. No.: US 2013/0073218 A1
(43) Pub. Date: Mar. 21, 2013

(54) SYSTEMS AND METHODS FOR MEASURING SUBSTANCES AND FOR ASCERTAINING AND/OR COMPUTING DATA PERTAINING TO MEASURED SUBSTANCES

(71) Applicant: Alfred M. Haas, Oakhurst, NJ (US)

(72) Inventor: Alfred M. Haas, Oakhurst, NJ (US)

(21) Appl. No.: 13/612,515

(22) Filed: Sep. 12, 2012

Related U.S. Application Data
(60) Provisional application No. 61/533,610, filed on Sep. 12, 2011.

(51) Int. Cl. G06F 19/00

(52) U.S. Cl. 702/23

(57) ABSTRACT

This invention pertains to methods and means for measuring substances and for ascertaining and/or computing data pertaining to measured substances. Various embodiments of the methods and means of the invention may be performed by and/or implemented in hardware, in software, by one or more entities, and/or by some combination of hardware, software and/or one or more entities.

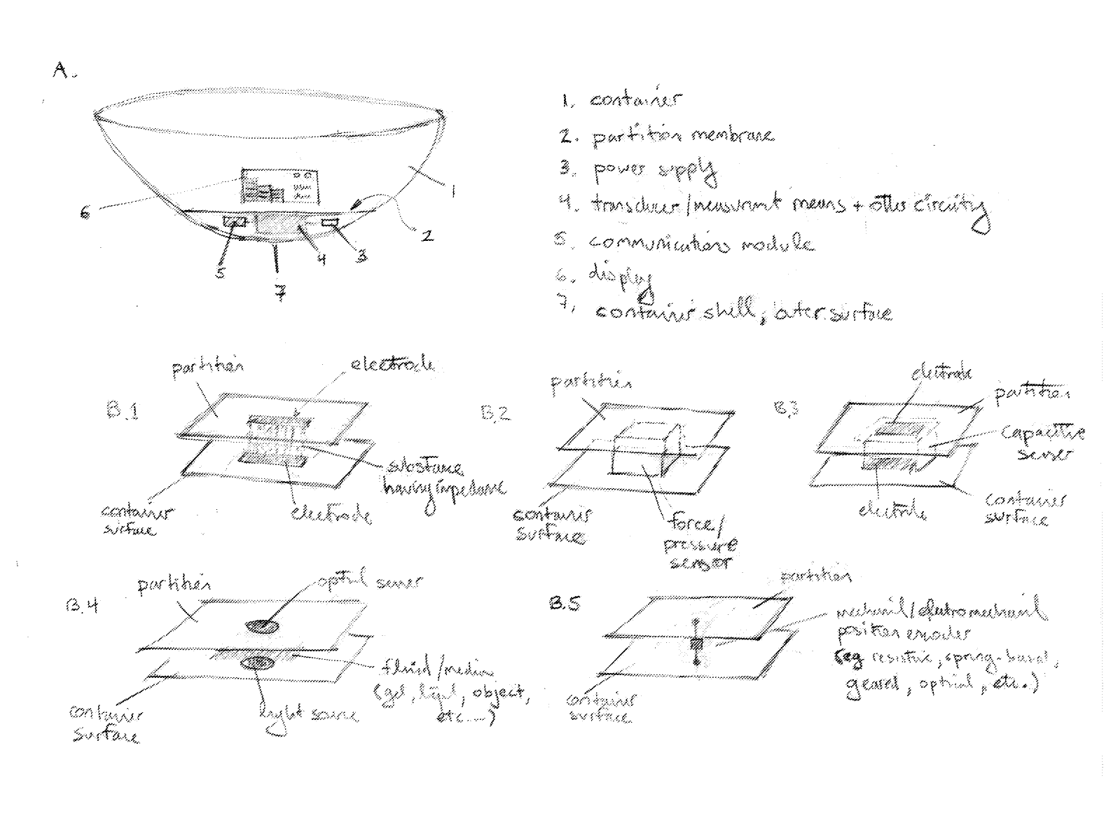

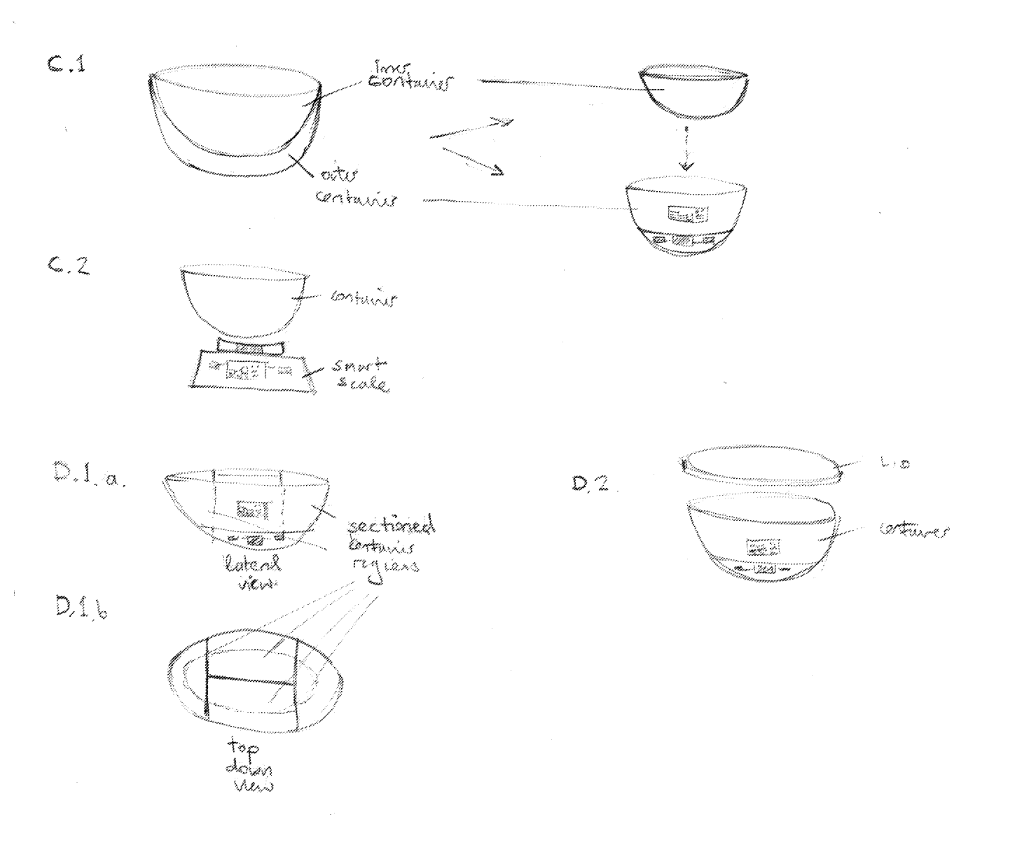

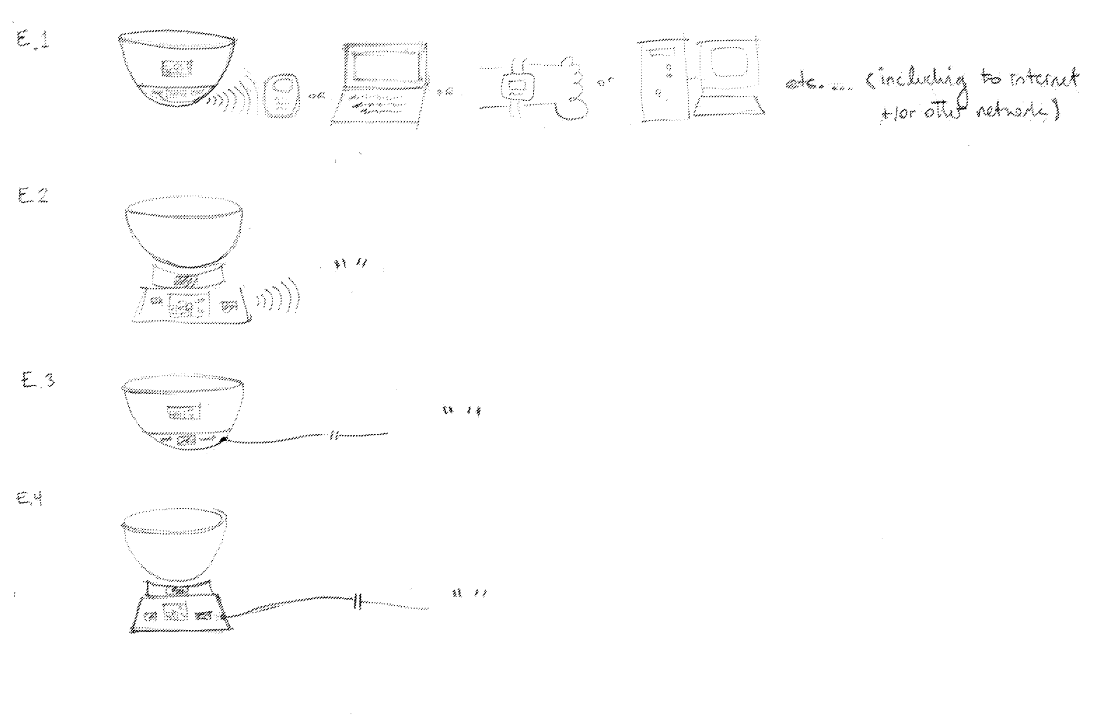

### CROSS-REFERENCE TO RELATED APPLICATIONS

Pursuant to 35 USC §119(e) and as set forth in the Application Data Sheet, this utility application claims the benefit of priority from U.S. Provisional Patent Application No. 61/533,610 (“the '610 provisional”) which is incorporated herein in its entirety by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This invention claims priority from the '610 provisional and expressly incorporates by reference the disclosures contained therein in their entirety, including but not limited to all patents, patent applications, and publications which are incorporated by reference in the '610 provisional and which are incorporated by reference herein in their entirety.

In the context of the instant disclosure, the term “software” is taken in the broadest sense of its ordinary meaning and illustrative examples may comprise, but are not limited to, one or more of the following: realized embodiments of algorithms in any form, code written in whole or in part in any programming, scripting or other language (including, but not limited to, popular languages such as C++, Java, Visual Basic, Python, PHP, HTML, and/or device specific machine or assembly languages, etc . . . ), programs, mobile and/or other applications (e.g., those for Android and iOS based systems), applets, scripts, operating systems (OS) and components of OS, embedded and other software and instructions, structured data, op codes, commands, executables, firmware, drivers, virtual machines, and/or instruction sets for a system, etc . . . Software may operate at many levels including, but not limited to, over a distributed system (e.g., on a cloud computing or mobile network), on a particular device, on a local computer or other machine, embedded in an ASIC or other circuit, and running on top of one or more real or virtual levels, including but not limited to an OS and a hardware level.

In the context of the instant disclosure, the term “hardware” is taken in the broadest sense of its ordinary meaning and illustrative examples may comprise, but are not limited to, one or more of the following: smart and other scales, thermostats, e-readers (e.g. Kindle™ and Nook™), hearing aids, laptop and desktop computers, alarms, smart phones, PDAs, other commercially available electronic devices such as tablet PCs, netbooks, e-readers, pagers, beepers, cell phones, hearing aids, watches comprising integrated and/or discrete circuits, monitors and displays, televisions, calculators, iPods™ and MP3 players, radios and stereos, speakers, microphones, remote controls, bar code readers, keyboards, cameras, other input devices, data acquisition systems, other physical devices and systems comprising integrated and/or discrete circuits, CPUs, hard drives, flash USB drives, other flash and solid state drives, programmable logic arrays, FPGAs, CPLDs, microcontrollers, digital signal processors, memories, receivers, transmitters, drivers, ADC's (analog-to-digital converters), DAC's (digital-to-analog converters), decoders, multiplexers, comparators, latches, gates, op amps, LNA (low noise amplifiers), PLL (phase locked loops), antennae, coils, radio frequency identification (“RFID”) devices, near-field communication (“NFC”) devices, capacitors, inductors, resistors, transformers, solenoids, other analog circuits and components, other digital circuits and components, other mixed-signal circuits and components, optical circuits, other electromagnetic circuits and components, biological and/or chemical circuits, assemblies of memristors, carbon nanotubes, etc . . . .

Some embodiments of the methods and means of the instant invention may employ one or more existing wireless and/or wired communication protocols, or other custom protocols. Illustrative examples of current and historical protocols, programs and standards for digital communication include: the Internet Protocol Suite; e-mail protocols such as POP (Post Office Protocol), SMTP (Simple Mail Transfer Protocol), IMAP (Internet Message Access Protocol), and MAPI (Messaging Application Programming Interface); web browsers such as Safari™, Internet Explorer™ and Firefox™; messaging programs, protocols and standards such as WLM (Windows Live Messenger), MSNP (Microsoft Notification Protocol), AIM (AOL Instant Messenger), ICQ, XMPP (Extensible Messaging and Presence Protocol), IRC (Internet Relay Chat), MIM (Mobile Instant Messaging), SMS (Short Message Service), WAP (Wireless Area Protocol), GPRS (General Packet Radio Service), WLAN (Wireless Local Area Network), Bluetooth™, and Skype™; mobile standards such as GSM (Global System for Wideband Communications), W-CDMA (Wideband Code Division Multiple Access), LTE (Long Term Evolution), and LTE-Advanced, WirelessMAN (Metropolitan Area Networks)-Advanced; NFC (near-field communications), and many others not addressed here. To the extent that documented versions of these protocols, programs and standards are publicly accessible they are incorporated herein by reference. Likewise, some embodiments of the methods and/or means of the instant invention may employ analog and/or mixed-signal methods of communicating data or information. In addition, some embodiments of the invention employ GPS (Global Positioning System) and aGPS (Assisted Global Positioning System) protocols and/or standards.

The following publications and software packages contain information related to the design, development, fabrication, production, assembly, and other aspects of embodiments of the disclosed invention—including, but not limited to, software and hardware such as sensors and transducers, circuits, transmitters, receivers, housings, wearable and other mobile devices, optics, programmable logic elements and chips, custom ASICs, electrical and mechanical switches, electrical and mechanical regulators, etc.: Analysis and Design of Analog Integrated Circuits by Paul R. Gray, Paul J. Hurst, Stephen H. Lewis, Robert G. Meyer, published by John Wiley & Sons, copyright 2001; Digital Principles and Design by Donald D. Givone, published by McGraw Hill copyright 2003; Physics by Paul A. Tipler, published by Worth Publishers, copyright 1976; The New Way Things Work by David Macaulay, published by Houghton Mifflin, copyright 1988; CMOS Circuit Design, Layout and Simulation by R. Jacob Baker, published by the Institute of Electrical and Electronics Engineers, copyright 2005; Microelectronic Circuits by Adel S. Sedra and Kenneth C. Smith, published by Oxford University Press, copyright 1998; Thin Film Technology Handbook by Aicha Elshabini-Riad, Fred D. Barlow III, published by McGraw-Hill, copyright 1998; Field and Wave Electromagnetics by David K. Cheng, published by Addison-Wesley, copyright 1989; VLSI for Wireless Communications by Bosco Leung, published by Prentice Hall, copyright 2002; Complete Wireless Design by Cotter W. Sayre, published by McGraw Hill, copyright 2001; Pattern Classification, Second edition by Richard Duda, Peter Hart and David Stork, published by John Wiley & Sons, Inc., copyright 2001; C++ How to Program, Third edition by H. Dietel & P. Dietel, published by Prentice Hall, copyright 2001; Professional Android 2 Application Development by Roto Meier, published by Wiley Publishing, Inc., copyright 2010; the various versions of the Android SDK; the various versions of the Internet Protocol Suite; the various versions of the iOS SDK; the various versions of the Windows and Windows Mobile SDKs. All publications cited herein are hereby incorporated by reference in their entirety.

The discussion of the background of the invention herein is included to explain the context of the invention. Although each of the patents, patent applications, and publications cited herein are hereby incorporated by reference, neither the discussion of the background nor the incorporation by reference is to be taken as an admission that any aspect, element, embodiment, or feature of the invention was published, known, or part of the common general knowledge as of the priority date of any claims of the invention.

### BRIEF SUMMARY OF THE INVENTION

The invention disclosed herein relates to methods and means for measuring substances and for ascertaining and/or computing data pertaining to measured substances. Various embodiments of the methods and means of the invention may be performed by and/or implemented in hardware, in software, by one or more entities, and/or by some combination of hardware, software and/or one or more entities.

### BRIEF DESCRIPTION OF THE SEVERAL VIEWS OF THE DRAWING

FIG. A illustrates one specific example of a container according to an embodiment of the instant invention.

FIGS. B.1-B.5 illustrate specific examples of measuring means according to some embodiments of the instant invention.

FIG. C.1 illustrates a specific example of an embodiment of a container that comprises two or more separable pieces, in this case comprising an inner container and an outer container. FIG. C.2 shows a specific example of an embodiment of the invention where a conventional (ordinary) container is paired with a smart scale having integrated electronics, display, communications module and power supply.

FIGS. D.1-D.2 illustrate specific examples of containers according to some embodiments of the instant invention that are internally sectioned and also that may be closed and/or sealed, for example with a lid.

FIGS. E.1-E.4 illustrate specific examples of some embodiments of the invention in which a container and/or a smart scale may operate in conjunction with and are capable of transmitting data to and/or receiving data from an external device, system, or network using wires and/or wireless transmission methods.

### DETAILED DESCRIPTION OF THE INVENTION

This invention relates to methods and means for measuring substances and for ascertaining and/or computing data pertaining to measured substances. In some embodiments, the methods and means of the invention comprise some combination of hardware and/or software.

Although it is not believed that drawings are necessary for the understanding of the subject matter sought to be patented, for illustrative purposes we have included several figures related to specific examples of embodiments of the disclosed invention.

FIG. A illustrates one specific example of a container according to an embodiment of the instant invention. In FIG. A, the container, (1), comprises a shell, (7), with inner and outer surfaces and an enclosed region that is defined and bounded by a portion of the inner surface of the shell, (7), and by a partition membrane, (2), having a bottom and a top surface, with the bottom surface of the partition membrane forming a top of the enclosed region and the top surface of the partition membrane defining the bottom boundary of a usable region of the container, with the usable region of the container in this example being further defined and bounded by the inner surface of the shell that does not define or bound the enclosed region. An integrated transduction/measurement means, (4), is embedded in the enclosed region of the container shown in FIG. A along with additional circuitry, represented schematically by labeled blocks (4) and (5), for ascertaining and/or computing data concerning measured substances and for performing other functions, including but not limited to communicating and/or interfacing with other circuits, components, devices, systems, networks and individuals, driving one or more display elements, processing and transmitting data, processing and transmitting power, storing and retrieving data, as well as for such miscellaneous functions as, e.g. waking and sleeping. The specific example illustrated schematically in FIG. A also comprises a power supply, (3), a communications module, (5), and a display (6).

FIGS. B.1-B.5 illustrate specific examples of measuring means according to some embodiments of the instant invention. FIG. B.1 illustrates one example of a simple impedance sensor according to an embodiment of the invention where a compressible substance and/or fluid having an impedance is disposed between two electrodes where one electrode is situated on a bottom surface of a partition membrane, and another electrode situated on top of an inner surface of a container shell. FIG. B.2 shows an example of a generic force and/or pressure sensor according to an embodiment of the invention that is situated between a partition membrane and a surface in an enclosed region which could optionally be an inner surface of a shell. FIG. B.3 illustrates an example of a generic capacitance sensor according to an embodiment of the invention that may be used to measure a differential capacitance between two electrodes, in this specific example having one electrode on a surface of a partition membrane, and the other on a surface of a container shell. FIG. B.4 shows a schematic illustration of an example of an optical sensing means according to an embodiment of the invention wherein a light source is disposed onto a surface of a container shell and an optical sensor is situated on a bottom surface of a partition membrane, in this specific example with a substance that is less than 100% transparent disposed between the sensor and light source. FIG. B.5 shows an example of a generic electromechanical position sensor according to an embodiment of the invention.

FIG. C.1 illustrates a specific example of an embodiment of a container that comprises two or more separable pieces, in this case comprising an inner container and an outer container. FIG. C.2 shows a specific example of an embodiment of the invention where a conventional (ordinary) container is paired with a smart scale having integrated electronics, display, communications module and power supply.

FIGS. D.1-D.2 illustrate specific examples of containers according to some embodiments of the instant invention that are internally sectioned and also that may be closed and/or sealed, for example with a lid.

FIGS. E.1-E.3 illustrate some embodiments of the invention in which a container and/or a smart scale may operate in conjunction with and be capable of transmitting data to and/or receiving data from an external device, system, or network using wires and/or wireless transmission methods. Illustrative examples of external devices comprise, but are not limited to, smart and other scales, cell phones, tablet computers, PDAs, e-readers (e.g. Kindle™ and Nook™), hearing aids, laptop and desktop computers, monitors and displays, televisions, calculators, iPods™ and MP3 players, radios and stereos, watches with electrical circuits, remote controls, bar code readers, keyboards, cameras, other input devices, data acquisition systems, other electrical devices comprising, e.g., microcontrollers, programmable interface controllers, digital signal processors, memories, field programmable gate arrays, discrete circuits, and other electrical circuits and hardware, including custom application specific integrated circuits (ASIC). In some embodiments of the instant invention, refrigerators having appropriate circuitry (e.g. microcontrollers, DSPs, transceiver modules, input devices, etc . . . ) may comprise external devices and/or systems as defined herein. In addition, the world-wide-web, the Verizon™ wireless 4G LTE™ cellular network, and LANs are three illustrative examples of networks.

It should be noted that the figures and examples they represent are provided for illustrative purposes only and are not intended to limit the scope of the instant invention.

Although the foregoing invention has been described in some detail by way of illustration and example for purposes of clarity and understanding, it will be readily apparent to those of ordinary skill in the art in light of the teachings of this invention that certain changes and modifications may be made thereto without departing from the spirit and purview of this application or scope of the appended claims. All publications, patents, and patent applications cited herein are hereby incorporated by reference in their entirety.

I claim:

1. A means comprising hardware for measuring quantities of substances and for ascertaining and for computing data concerning measured quantities of substances.

2. The means of claim 1 wherein the hardware comprises one or more of a cell phone, a tablet computer, a worn device comprising a microprocessor, and a personal digital assistant.

3. A container comprising hardware for measuring quantities of substances and for ascertaining and for computing data concerning measured substances.

4. A method for measuring quantities of substances and for ascertaining and for computing data concerning measured substances.

5. The method of claim 4 comprising the steps of measuring the weight of one or more substances, retrieving data pertaining to the substances, and computing data concerning the substances.

6. The method of claim 5, wherein computing data concerning the substances comprises the step of computing the nutritional content of the substances.
